(19) United States
(12) Patent Application Publication
(10) Pub. No.: US 2017/0126845 A1
(43) Pub. Date: May 4, 2017

(54) NETWORK COMMUNICATION SYSTEM

(71) Applicant: VTX Holdings (Singapore) Pte. Ltd., Singapore (SG)

(72) Inventors: Robert William Pole, Torbay (NZ); Cameron Brett Worth, Subiaco (AU)

(73) Assignee: VTX Holdings (Singapore) Pte. Ltd., Singapore (SG)

(21) Appl. No.: 14/927,268

(22) Filed: Oct. 29, 2015

(51) Int. Cl. H04L 29/06; H04L 12/46; H04L 12/26; H04L 12/741

(52) U.S. Cl. CPC H04L 69/04; H04L 45/745; H04L 12/4641; H04L 43/0864

(57) ABSTRACT

A network communication system for communicating data from a source network location to a destination network location is described. The system has a source network device that buffers received source data packets and combines the payload data of the plurality of received source data packets, compresses the combined payload data and adds a custom packet header to the compressed combined payload data so as to produce a custom data packet. The system also comprises a destination network device that buffers the received custom data packet, decompresses the combined payload data in the custom data packet, separates the respective decompressed payload data associated with the respective source data packets, and recreates the source data packets from the decompressed separated payload data.

### FIELD OF THE INVENTION

The present invention relates to a network communication system, and in particular to a communication system for improving network bandwidth in Internet communications.

### BACKGROUND

The Internet is a very large scale internet protocol (TCP/IP) based data network that is used to communicate information between computing devices, including personal computers, tablet computers and smartphones. Such information may be time critical or non-time critical.

Non-time critical information is typically communicated through the Internet using TCP protocol, which includes quality of service measures that operate to guarantee delivery of accurate data. If any data packets do not arrive safely at a destination, the packets are resent. TCP is for example typically used for Internet browsing, email and file transfer applications.

Time critical information is typically communicated through the Internet using UDP protocol, which does not include quality of service measures such as guarantee of delivery and as such any packets that do not arrive on time are lost. UDP is for example typically used for real-time audio/visual communications.

When information is passed to a user computing device from a remote server, the information typically passes from the remote server through several networks and routing devices to the user computing device, and typically a significant determining factor in the overall bandwidth available between the server and user computing device is the bandwidth available through a section of the communication path that is adjacent the user computing device. This section of the communication path is referred to in this specification as the ‘last mile’ of the communication path.

### SUMMARY

In accordance with a first aspect of the present invention, there is provided a network communication system for communicating data from a source network location to a destination network location, the system comprising:

a source network device comprising a source data packet buffer arranged to buffer a plurality of received source data packets that are desired to be sent from the source network location to the destination network location, the source network device arranged to combine the payload data of the plurality of received source data packets;

the source network device comprising a source compressor arranged to compress the combined payload data in the source data packets buffered in the source data packet buffer to produce compressed combined payload data, the source network device arranged to add a custom packet header to the compressed combined payload data so as to produce a custom data packet; and

the system comprising:

a destination network device comprising a destination data packet buffer arranged to buffer a custom data packet that is received at the destination network location from the source network location;

the destination network device comprising a destination decompressor arranged to decompress the combined payload data in the custom data packet in the destination data packet buffer to produce decompressed combined payload data; and

the destination network device arranged to separate the respective decompressed payload data associated with the respective source data packets and recreate the source data packets from the decompressed separated payload data.

In an embodiment, each source data packet has a source data packet header and a source data packet payload, and the source network device is arranged to remove the source data packet header from each source data packet prior to compression of the plurality of source data packets.

In an embodiment, the destination network device is arranged to add source data packet headers to the respective separated payload data so as to thereby recreate the source data packets.

In an embodiment, the custom data packet is a UDP data packet.

In an embodiment, the source network device comprises at least one source application arranged to implement at least compression of the combined payload data.

In an embodiment, the source network device comprises a source TUN interface arranged to provide an interface between a kernel of the source network device and the source application.

In an embodiment, the source application is downloadable and installable on a source computing device so as to at least partially implement the source network device on the source computing device.

In an embodiment, the destination network device comprises at least one destination application arranged to implement at least decompression of the compressed combined payload data.

In an embodiment, the destination network device comprises a destination TUN interface arranged to provide an interface between a kernel of the destination network device and the destination application.

In an embodiment, the destination application is downloadable and installable on a destination computing device so as to at least partially implement the destination network device on the destination computing device.

In an embodiment, the source network device comprises a source VPN network interface and the destination network device comprises a destination VPN network interface, the source and destination VPN network interfaces creating a VPN tunnel between the source and destination network devices. The VPN tunnel may be arranged to use a base SSL connection.

In an embodiment, payload data of one or more of the source packets is compressed using ASCII compression. In response to compression of source packet payload data using ASCII compression, the source network device may be arranged to add an ASCII compression flag to the custom packet header.

In an embodiment, the destination network device is arranged to detect the ASCII compression flag in the custom packet header, and in response to decompress the associated ASCII compressed payload data.

In an embodiment, the source network device is arranged to compress the combined payload data using a data compression algorithm. A plurality of data compression algorithms may be available and the source network device may be arranged to select a data compression algorithm based on defined criteria. The data compression algorithms may include a ZLib compression algorithm and a Brotli compression algorithm.

In an embodiment, the source network device is arranged to add a combined payload compression flag to the custom packet header to indicate which compression algorithm has been used to compress the combined payload data.

In an embodiment, the source network device is arranged to send a source data packet to the destination network device without combining with other source data packets and without compression in response to defined criteria. The defined criteria may include whether the source data packet is latency sensitive.

In an embodiment, the source network device includes a serialiser arranged to serialise the payload data of a plurality of packets that are added to the soured data packet buffer, and the destination network device include a de-serialiser arranged to de-serialise the payload data in a received custom packet.

In an embodiment, the custom header includes reliability metadata. The reliability metadata may include data indicative of a sequence number allocated to the custom packet, data indicative of the last custom packet that was received at the source network device from the destination network device, and/or data indicative of a plurality of most recent custom packets that have been received at the source network device from the destination network device.

In an embodiment, the source network device includes a source sent packets cache arranged to store a plurality of recent custom packets that have been sent from the source network device to the destination network device.

In an embodiment, the destination network device is arranged to request retransmission of a custom packet from the source sent packets cache if the reliability metadata indicates that the custom packet has not been received at the destination network device.

In an embodiment, the source sent packets cache includes metadata indicative of the time that a custom packet is sent from the source network device to the destination network device; an acknowledge receive time indicative of the time than an acknowledgement is received for a custom packet from the destination network device; and/or data indicative of the number of times that a custom packet has been sent from the source network device to the destination network device.

In an embodiment, the source network device is also arranged to calculate an average round rip time (RTT) for a custom packet, the RTT indicative of an average time taken between sending a custom packet and receiving an acknowledgment for the custom packet.

In an embodiment, the source network device is arranged to make a determination as to the packet send rate at which to send custom packets from the source network device to the destination network device based on the RTT.

In an embodiment, the source network device is arranged to manage the timing of compression of combined data in the source data packet buffer based on:

i) the time since a first source packet data payload was added to the buffer comparison with a buffer fill time threshold;

ii) the number of source packets added to the source data packet buffer and comparison with a buffer packet number threshold; and/or

iii) the total size of data in the source data packet buffer and comparison with a buffer size threshold;

and to compress the combined payload data in the source data packet buffer if any of the thresholds are exceeded.

In an embodiment, the source network device is arranged to make a determination as to whether a custom packet has most likely been lost based on the time elapsed since the custom packet was sent without receiving an acknowledgement, and to retransmit the custom packet from the source sent packets cache if the determination indicates that the custom packet has most likely been lost.

In an embodiment, the custom header includes data indicative of the type of custom packet.

In an embodiment, the source network device includes a source packet cache manager having a source duplication cache and the destination network device includes a destination packet cache manager having a destination duplication cache.

In an embodiment, the source packet cache manager includes a source packet fingerprinter arranged to generate unique fingerprint data representative of a custom packet to be sent from the source network device, and to store the generated fingerprint data and the associated custom packet in the source duplication cache; and the destination packet cache manager includes a destination packet fingerprinter arranged to generate the unique fingerprint data representative of a custom packet received at the destination network device, and to store the generated fingerprint data and the associated received custom packet in the destination duplication cache.

In an embodiment, when a custom data packet has already been sent from the source network device to the destination network device, the source network device is arranged to send the fingerprint data associated with an already sent custom packet to the destination network device, and the destination network device is arranged to use the received fingerprint data to retrieve the custom packet from the destination duplication cache.

In an embodiment, the custom header includes data indicative of whether the source cache and the destination cache are in sync.

In an embodiment, the source network device includes a source control packet manager and the destination network device includes a destination control packet manager, the source and destination control packet managers arranged to manage control packets that pass between the source and destination network devices, the control packets containing routing and scheduling information.

In accordance with a second aspect of the present invention, there is provided a source network device for communicating data to a destination network device, the source network device comprising:

a source data packet buffer arranged to buffer a plurality of received source data packets that are desired to be sent from the source network location to the destination network location, the source network device arranged to combine the payload data of the plurality of received source data packets; and

a source compressor arranged to compress the combined payload data in the source data packets buffered in the source data packet buffer to produce compressed combined payload data, the source network device arranged to add a custom packet header to the compressed combined payload data so as to produce a custom data packet.

In accordance with a third aspect of the present invention, there is provided a server computing device comprising a source network device according to the second aspect of the present invention. The source network device may be implemented at least partially by a server application that may be downloaded and installed on the server computing device.

In accordance with a fourth aspect of the present invention, there is provided a destination network device for receiving data communicated from a source network device, the destination network device comprising:

a destination data packet buffer arranged to buffer a custom data packet that is received at the destination network location from the source network location; and

a destination decompressor arranged to decompress the combined payload data in the custom data packet in the destination data packet buffer to produce decompressed combined payload data;

the destination source network device arranged to separate the respective decompressed payload data associated with the respective source data packets and recreate the source data packets from the decompressed separated payload data.

In accordance with a fifth aspect of the present invention, there is provided a client computing device comprising a destination network device according to the fourth aspect of the present invention. The destination network device may be implemented at least partially by a client application that may be downloaded and installed on the client computing device.

In the above embodiments, the source network device may be arranged to implement functionality associated with the destination network device, and the destination network device may be arranged to implement functionality associated with the source network device.

### DESCRIPTION OF THE DRAWINGS

The present invention will now be described, by way of example only, with reference to the accompanying drawings, in which:

FIG. 1 is a diagrammatic representation of a typical Internet network arrangement that supports TCP/IP communications;

FIG. 2 is a conceptual overview block diagram of a network communication system in accordance with an embodiment of the present invention;

FIG. 3 is a block diagram of the network communication system shown in FIG. 2 illustrating components of the system;

FIG. 4 is a block diagram of a packet buffer manager of the system shown in FIG. 3;

FIG. 5 is a table illustrating contents of a custom packet produced by the system shown in FIG. 3;

FIG. 6 is a diagrammatic representation of packet flow through a VPN tunnel of the system shown in FIG. 3;

FIG. 7 is a flow diagram illustrating steps of a method of generating custom packets for use with the system shown in FIG. 3;

FIG. 8 is a flow diagram illustrating a method of restoring packets from a custom packet created according to the method shown in FIG. 7;

FIG. 9 is a block diagram of reliability and congestion control components of the system shown in FIG. 3; and

FIG. 10 is a block diagram of components of a packet cache manager of the system shown in FIG. 3.

### DETAILED DESCRIPTION

For the purpose of this specification the term ‘inbound’ refers to data that travels to the client device 14 from a remote server, and the term ‘outbound’ refers to data that travels from the client device 14 to the remote server.

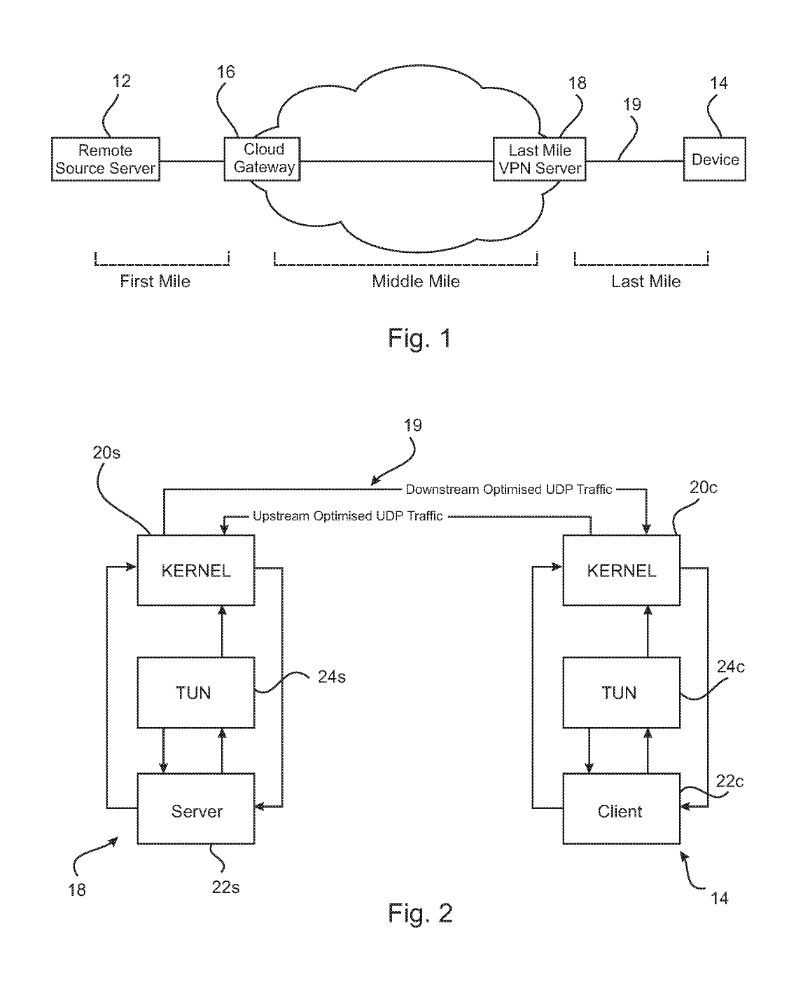

Referring to FIG. 1 of the drawings, an arrangement is shown that represents a typical communications arrangement across the Internet wherein a remote server 12 communicates with a client computing device 14, such as a personal computer, tablet computer or smartphone. In this example, a communication from the remote server 12 passes through a cloud gateway 16 and a VPN server 18 that is arranged to connect with the client device 14 through a virtual private network (VPN). The VPN establishes a network tunnel 19 between the VPN server 18 and the client device 14 that facilitates secure communications to and from the client device 14 across the tunnel 19. In the present specification, the terms ‘VPN connection’ and ‘tunnel’ are used interchangeably.

The present system provides a degree of optimisation of communications between the client device 14 and the VPN server 18, that is, at the ‘last mile’ of the communication path between the remote server 12 and the client device 14.

The VPN server 18 and the client device 14 are shown conceptually in FIG. 2. The client device 14 includes a client kernel 20c, a client application 22c and a TUN interface 24c arranged to provide a virtual interface for network data between the kernel 20c and the client application 22c. Similarly, the VPN server 18 includes a VPN server kernel 20s, a server application 22s and a TUN interface 24s arranged to provide a virtual interface for network data between the kernel 20s and the server application 22s.

During use, data that is desired to be sent over the network through the tunnel 19 is passed to the client/server application 22c, 22s through the relevant TUN interface 24c, 24s by the relevant kernel 20c, 20s, and the client/server application optimises the network data and passes the optimised data back to the kernel through the TUN interface 24c, 24s for transmission. Optimisation of the data is achieved by creating a compressed custom packet from multiple source packets that has a payload derived from the payloads of multiple source packets, and a single custom header for all source packets that have been incorporated into the custom packet and that includes a custom reliability component.

It will be understood that combining multiple source packets in this way significantly reduces meta-data overhead because significantly less header data is required to be transmitted. Combining multiple source packets also has the advantage of facilitating better data compression since significantly more data is available for compression than would be available in a single source packet.

The custom packets are compressed and communicated through the tunnel 19 using UDP irrespective of whether the source packets are of TCP or UDP type, since UDP has much simpler communication requirements.

At the opposite side of the tunnel 19, the relevant kernel 20c, 20s passes the compressed custom packets through the relevant TUN interface 24c, 24s to the relevant client or server application 22c, 22s which decompresses the custom packets, separates the original source packet payload data from the custom packet, adds headers to each of the recreated source packets and passes the recreated source packets back to the relevant kernel through the relevant TUN interface 24c, 24s for onward transmission to the relevant remote server 12 or client device 14.

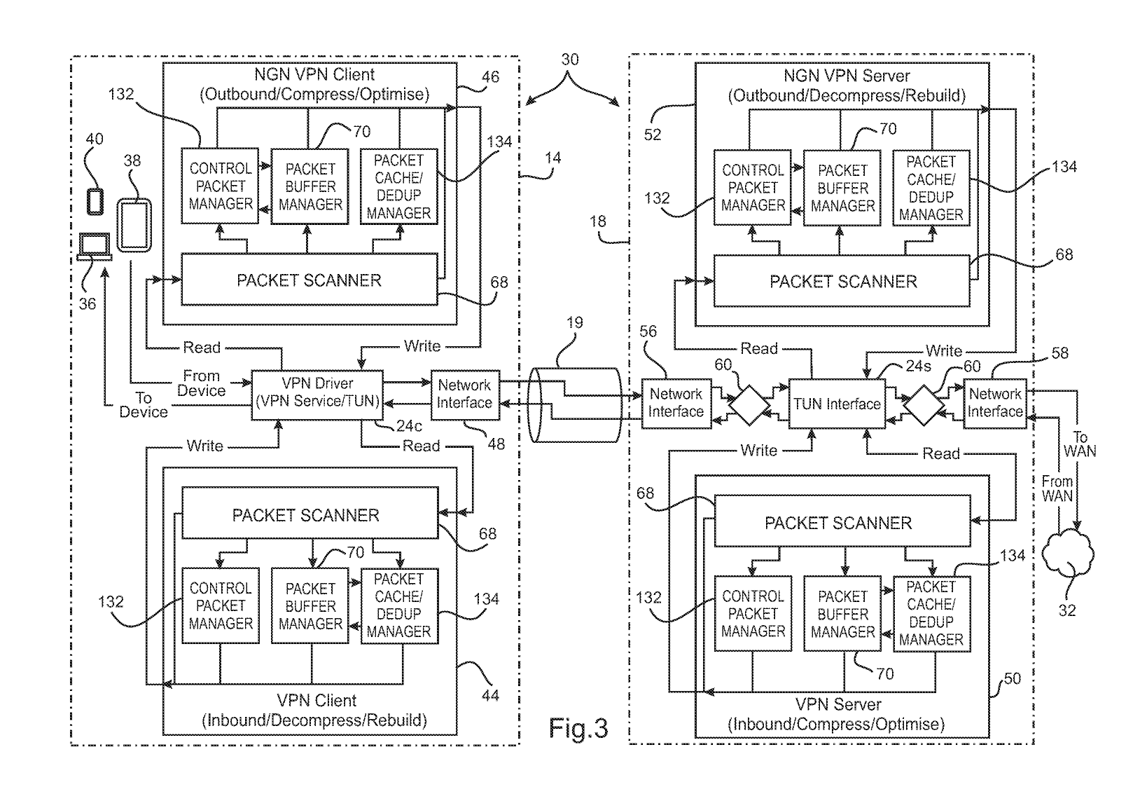

Referring to FIG. 3, components of a network communication system 30 are shown in more detail. Like and similar features are indicated with like reference numerals.

The system 30 includes a client device 14 that communicates with a VPN server 18 through a VPN tunnel 19 that has been established by the client device 14 and VPN server 18. As indicated above, the VPN tunnel 19 extends across the ‘last mile’ of the communication path between the client device 14 and a remote server (not shown) that for example is in communication with the client device 14 through a WAN 32.

As indicated, the client device 14 may take the form of a personal computer 36, tablet computer 38 or smartphone 40, although it will be understood that any suitable computing device is envisaged. It will be understood that the client device is shown conceptually in FIG. 3 and while the client device 14 may for example be a personal computer 36, tablet computer 38 or smartphone 40, the components of the client device 14 illustrated in FIG. 3 would be incorporated in and form part of the personal computer 36, tablet computer 38 or smartphone 40.

The client application 22c in this example may be downloadable from a remote applications server, and installed on the client device 14 in order to cause the client device 14 to implement the functionality of the system at the client device 14.

Similarly, the server application 22s in this example may be downloadable from a remote applications server, and installed on a server computing device 14 in order to cause the server computing device to implement the functionality of the system at the VPN server 18.

The client device 14 includes an inbound packet manager 44 and an outbound packet manager 46 that are arranged to perform complimentary functions for data that travels in different directions across the tunnel 19. The packet managers 44, 46 in this example are implemented using a client application that is installed on the client device 14, and the packet managers 44, 46 are arranged to optimise network data that is sent across the tunnel 19 by creating custom packets and compressing the custom packets, to manage decompression of custom packets that are received from the tunnel 19, manage recreation of the original source packets, and manage control aspects of packet transfer across the network.

Each of the packet managers 44, 46 communicates with a VPN driver that serves as a TUN interface 24c arranged to facilitate passage of data packets between the client device kernel 20c and the client application represented in this example by the packet managers 44, 46. Data packets that are passed to the client device kernel 20c by the TUN interface 24c are transferred to the physical network (and thereby the VPN tunnel 19) through a network interface 48 if the data packets are outbound data packets, or to a device application running on the client device 14, such as an Internet browser, that is in communication with the remote server 12 and receiving data packets from the remote server 12.

The VPN server 18 is similar to the client device 14 and may take the form of a personal computer or dedicated computer server, although it will be understood that any suitable computing device is envisaged.

The VPN server 18 includes an inbound packet manager 50 and an outbound packet manager 52 that are arranged to perform complimentary functions for data that travels in different directions across the tunnel 19. The packet managers 50, 52 in this example are implemented using a server application that is installed on the VPN server 12, and, in a similar way to the packet managers 44, 46 of the client device 14, the packet managers 50, 52 are arranged to optimise network data that is sent across the tunnel 19 by creating custom packets and compressing the custom packets, to manage decompression of custom packets that are received from the tunnel 19, manage recreation of the original source packets, and manage control aspects of packet transfer across the network.

Each of the packet managers 50, 52 communicates with a TUN interface 54 arranged to facilitate passage of data packets between the VPN server kernel 20s and the server application represented in this example by the packet managers 50, 52. Data packets that are passed to the VPN server kernel 20s by the TUN interface 24s are transferred to the physical network and the VPN tunnel 19 through a tunnel network interface 56, or to the physical network and the WAN and ultimately the remote server 12 through a WAN network interface 58.

The VPN server 18 also includes routing devices 60 arranged to carry out appropriate IP routing as required.

During use, source data packets that are generated at a user computing device 36, 38, 40 are passed by the client TUN interface 24c to the client outbound packet manager 46 which processes the source packets and produces optimised custom data packets. The customised data packets are then passed back to the client TUN interface 24c for transmission across the tunnel 19 to the VPN server 18.

On receipt of the custom packets at the VPN server 18, the custom packets are passed by the server TUN interface 24s to the server outbound packet manager 52 which processes the custom packets and recreates the original source packets from the client device 14. The recreated source packets are then passed back to the server TUN interface 24s for transmission to the remote server 12 through the WAN network interface 58 and WAN 32.

A similar process occurs when data packets are generated by the remote server for transmission to the client device 14.

With this process, source data packets that are generated at the remote server 12 and received at the WAN network interface 58 are passed by the server TUN interface 24s to the server inbound packet manager 50 which processes the source packets and produces optimised custom data packets. The customised data packets are then passed back to the server TUN interface 24s for transmission across the tunnel 19 to the client device 14.

On receipt of the custom packets at the client device 14, the custom packets are passed by the client TUN interface 24c to the client inbound packet manager 44 which processes the custom packets and recreates the original source packets from the remote server 12. The recreated source packets are then passed back to the client TUN interface 24c for transmission to the device application running on the client device 14 that is in communication with the remote server 12 and receiving data packets from the remote server 12.

Each of the packet managers 44, 46, 50, 52 includes a packet scanner 68, in this example implemented using an ASCII processor, that analyses each incoming original source packet and determines the most appropriate action to carry out in respect of the packet in order to improve efficiency of transfer of the data in the payload of the source packet, for example whether to compress using ASCII compression, or whether to apply other compression methodologies described in more detail below. The packet scanner 68 also analyses the incoming source packet to determine packet type, for example whether the source packet is a TCP type packet, a UDP type packet, a control packet, or a packet that is latency sensitive and therefore should be passed over the network without delay.

Each packet manager 44, 46, 50, 52 also includes a packet buffer manager 70 arranged to build custom packets, compress the payload data in the custom packets according to the compression regime determined by the packet scanner 68, rebuild original source packets, and decompress payload data in the custom packets.

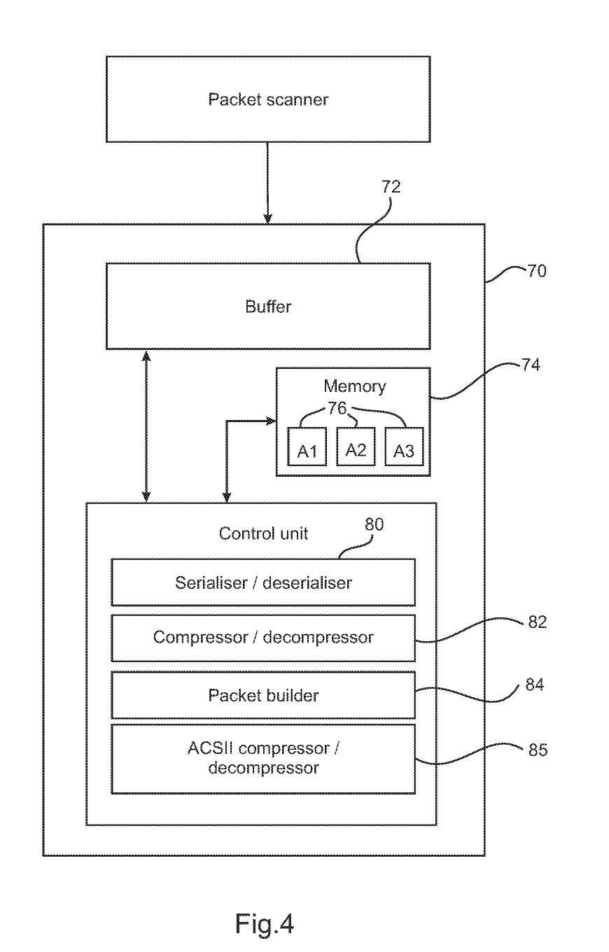

Components of the packet buffer manager 70 are shown in more detail in FIG. 4. The packet buffer 70 includes a buffer 72 arranged to receive and temporarily store multiple original source packet payloads; a memory 74 arranged to store information indicative of several compression regimes 76, including ASCII compression, ZLib compression and Brotli compression; and a control unit arranged to control and coordinate operations in the packet buffer manager 70.

The control unit 78 in this example is arranged to implement several functions and for this purpose the control unit includes or otherwise implements a serialiser/deserialiser 80 that is arranged to serialise the payloads of the source packets stored in the buffer 72, a compressor/decompressor 82 arranged to apply compression and decompression regimes to the source packet payload data and payload data of the custom packets respectively, a packet builder 84 arranged to construct custom UDP packets that include an enlarged payload derived from multiple source packets and a custom header, and an ASCII compressor/decompressor 85 arranged to apply ASCII compression and decompression to payload data.

In the present example, 6 payloads derived from original source packets are included in the enlarged payload, although it will be understood that any suitable number of original source packet payloads is envisaged.

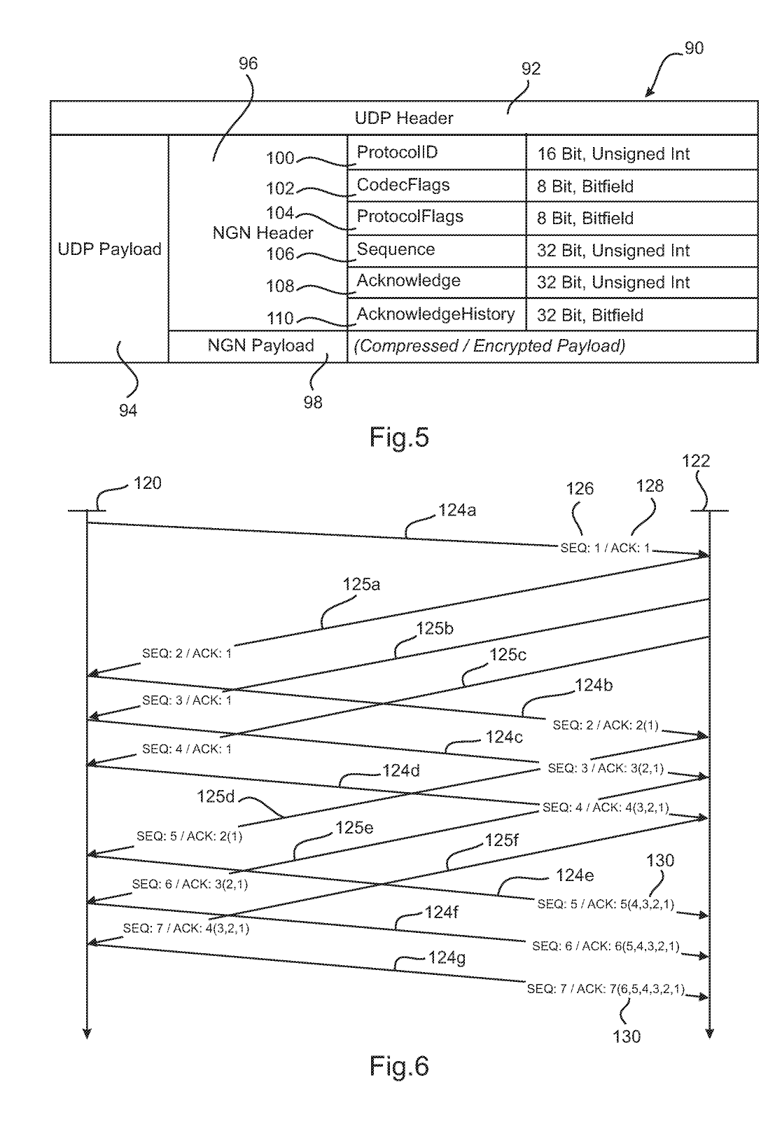

A custom UDP packet 90 is shown in FIG. 5. The custom packet 90 and custom packet methodology serves to avoid TCP retransmission overhead, and this is achieved by including a custom reliability and congestion control layer that uses the custom packet header.

The custom UDP header carries enough metadata to allow reliability and sequence rebuilding to be managed with minimal impact on transmitted data volume. The UDP transport layer handles delivery without the need for changes to existing hardware and drivers. Essentially, each custom packet is transmitted within a UDP payload.

Referring to FIG. 5, each custom packet 90 includes a conventional UDP header 92, and a ‘UDP payload’ 94 that comprises a custom header 96 and a custom payload 98.

The custom header 96 in this example is a fixed 16 byte block of data and includes the following header fields:

ProtocolID 100

CodecFlags 102

ProtocolFlags 104

Sequence 106

Acknowledge 108

AcknowledgeHistory 110

The ProtocolID field 100 provides an indication as to the type of packet, and in this example the packet type may be any one of the following:

111: Error/Reconnect

200: Authenticate/Handshake

201: Control packet

202: Compressed buffer

203: Cache hit/Duplicate

204: Untouched/Raw UDP packet

205: Untouched/Raw TCP packet

The CodecFlags field 102 contains flags indicative of the compression/decompression regime that has been used in relation to the custom payload 98, and in particular the compression state of each source payload in the custom payload and the overall compression regime used.

In the present example, the CodecFlags field 102 includes 8 bits as follows:

PacketCodec—Packet 1

PacketCodec—Packet 2

PacketCodec—Packet 3

PacketCodec—Packet 4

PacketCodec—Packet 5

PacketCodec—Packet 6

BufferCodec (LZ)

BufferCodec (Brotli)

A ‘1’ in a PacketCodec flag indicates that the respective source payload has been compressed with ASCII compression; a ‘1’ in a BufferCodec field indicates that the respective codec has been used to compress the payload data.

The ProtocolFlags field 104 contains flags indicative of special packet types and/or features that relate to network functionality. For example, a flag SyncCache may be included that is indicative of a request/response about whether caches at opposite sides of the tunnel 19 are in sync or need to be reset.

The Sequence field 106 records the sequence number for the custom packet 90 that is used to ensure that the original source packets are rebuilt at the tunnel exit in order. The Sequence field 106 is also used to request rebroadcast of the custom packet 90 if necessary.

The Acknowledge field 108 stores an ACK number indicative of the sequence number of the last custom packet 90 received at the sending side of the tunnel 19. For example, for a custom packet 90 that is sent from the VPN server 18 to the client device 14, the ACK number indicates the sequence number of the last custom packet that was received at the VPN server end of the tunnel 19. In this way, the client device is provided with an acknowledgement that the custom packet associated with ACK number was received at the VPN server 18.

The AcknowledgeHistory field 110 stores Boolean flags indicative of the previous 32 ACK numbers and in this way provides a summary of the custom packets that are acknowledged to have been received at the opposite side of the tunnel 19. For example, for a custom packet 90 that is sent from the VPN server 18 to the client device 14, a ‘1’ in a flag in the AcknowledgeHistory field 110 represents the sequence number of one of the last 32 custom packets 90 received at VPN server 18, and in this way the 32 flags provide the client device with an indication of which of the 32 previous custom packets sent by the client device 14 were received at the VPN server 18.

An example representation of packet flow through the tunnel 19 between a client side 120 of the tunnel 19 and a VPN server side 122 of the tunnel 19 is shown in FIG. 6.

Each arrow 124a-g represents a custom packet 90 that travels across the tunnel 19 from the client side 120 to the VPN server side 122, each arrow 125a-f represents a custom packet 90 that travels across the tunnel 19 from the VPN server side 122 to client side 120, and the sequence number 126, ACK number 128 and ACK history 130 are shown for each custom packet 90.

As shown, a custom packet 124a that is the first in a sequence of packets (sequence number 126 is 1) is sent from the client side 120 to the VPN server side 122.

The custom packet 124a includes an ACK number ‘1’ which acknowledges to the VPN server side 122 that a custom packet with sequence number ‘1’ has previously been received at the client side 120 from the VPN server side 122. A custom packet 125a with sequence number ‘2’ is then sent from the VPN server side 122 to the client side 120, the custom packet 125a including an ACK number ‘1’ which acknowledges to the client side 120 that a custom packet with sequence number ‘1’ has previously been received at the VPN server side 122. A custom packet 124b with sequence number ‘3’ (the third custom packet sent from the VPN server side 122) is then sent to the client side 120, the custom packet 125b including the same ACK number ‘1’ as the previous custom packet sent from the VPN server side 122 because no packet have been received at the VPN server side 122 since the last custom packet 125a was sent from the VPN server side 122. And so on. After more than one custom packet has been received at each side of the tunnel 19, an acknowledgement history develops that can be used to indicate to a first side of the tunnel 19 which previous custom packets have been received at a second opposite side of the tunnel 19. For example, a custom packet 124g sent from the client side 120 to the VPN server side 122 includes an ACK history 130 ‘6,5,4,3,2,1’ to acknowledge to the VPN server side that packet sequence numbers 1,2,3,4,5 and 6 sent from the VPN server side 122 to the client side 120 have all been received.

It will be appreciated that the ACK history 130 information can be used by a side of the tunnel 19 to determine which custom packets have not been received at the other side of the tunnel, and in response to retransmit the missing custom packet if necessary. In this way, using the AcknowledgeHistory field 110 the custom header facilitates an efficient reliability structure with redundancy in both directions.

Each packet manager 44, 46, 50, 52 also includes a control packet manager 132 that manages control packets passing between the client device 14 and the remote server 12, the control packets containing routing and scheduling information required for correct operation of a packet network.

Each packet manager 44, 46, 50, 52 also includes a packet cache manager 134 arranged to avoid duplication of transmission of data when the same data previously sent to the client device 14 or VPN server 18 is required at a subsequent time by the client device 14 or VPN server 18.

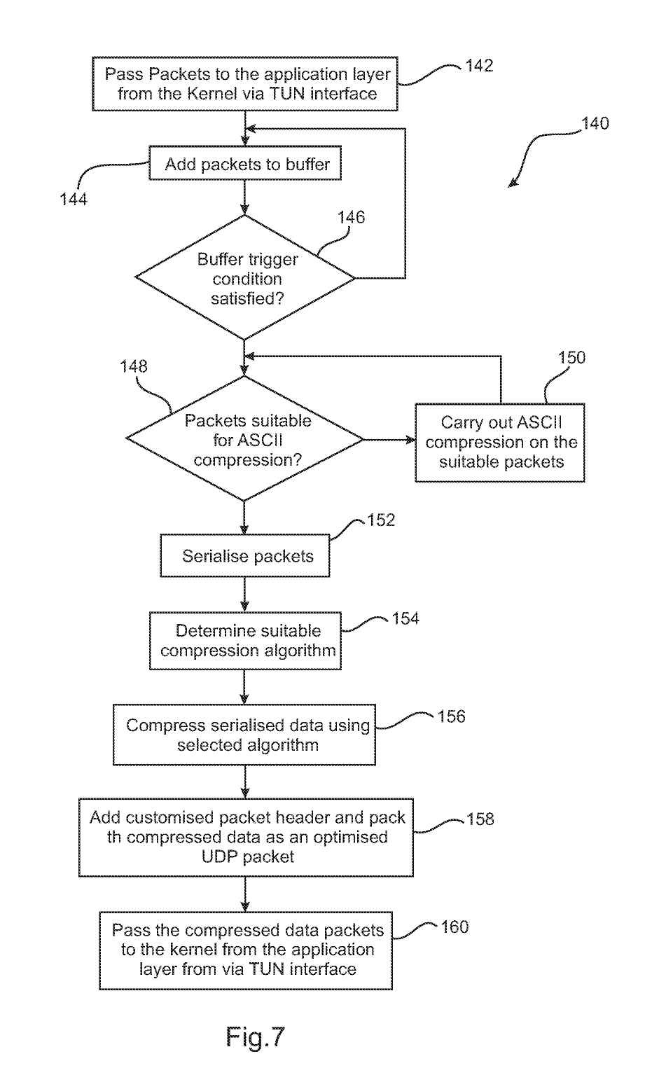

Referring to FIG. 7, a flow diagram 140 is shown that illustrates a method of generating custom packets implemented by the packet buffer manager 70 shown in FIG. 4 as original source packets arrive for transmission through the tunnel 19.

On arrival at the relevant kernel 20c, 20s of the client device 14 or VPN server 20s, the source packets are passed 142 to the application layer through the relevant TUN interface 24c, 24s for processing by the relevant client or server application 22c, 22s. During processing, the received source packets are added 144 to the buffer 72 and this continues until the buffer reaches capacity. When this occurs, a trigger condition is met 146, and an optimisation process is carried out on the contents of the buffer 72. As indicated at steps 148 and 150, if any of the source packets are suitable for ASCII compression, as identified by the packet scanner 68, ASCII compression is applied to the source packets and an appropriate flag added to the CodecFlags field 102 of the custom header 96. The source packets in the buffer are then serialised 152 using the serialiser/deserialiser 80 into a custom string (char/byte array) that incorporates minimal metadata indicative only of the boundaries between source packets in the serialised data.

As indicated at step 154, the packet scanner 68 analyses the incoming source packets and determines the most appropriate compression algorithm to use to compress the serialised data in the buffer 72. In this example, two compression algorithms are available: Brotli compression, that is used as the primary compression algorithm, and ZLib compression, that is used for particular versions of client/VPN server applications 22c, 22s, JAVA versions of the client/VPN server applications 22c, 22s, and when the load on the VPN server 18 is approaching an upper limit threshold. After selection of the most appropriate compression algorithm, the selected algorithm is applied 156 to the serialised data in the buffer 68 by the compressor/decompressor 82 to produce compressed payload data. The compressed data and a custom header 96 is then added 158 to a custom UDP packet 90, with the appropriate codec flag added to the CodecFlags field 102 of the custom header 96. The created custom UDP packets are passed to the relevant kernel 20c, 20s through the relevant TUN interface 24c, 24s for transmission through the tunnel 19.

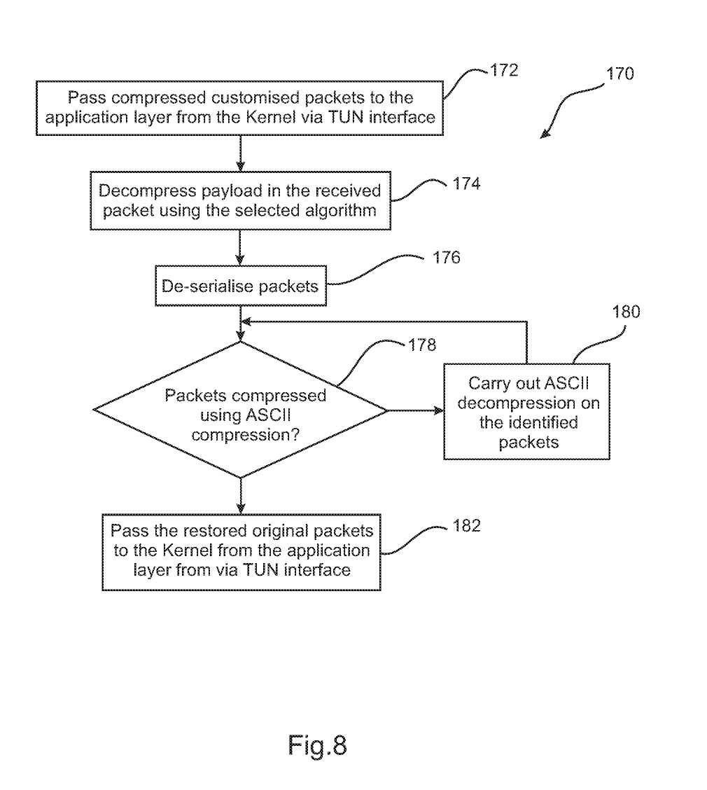

Referring to FIG. 8, a flow diagram 170 is shown that illustrates a method of recreating the original source packets that is implemented by the packet buffer manager 70 shown in FIG. 4 as the custom packets exit the tunnel 19.

After passing through the tunnel 19 and arriving at the relevant kernel 20c, 20s of the client device 14 or VPN server 20s, the source packets are passed 172 to the application layer through the relevant TUN interface 24c, 24s for processing by the relevant client or server application 22c, 22s. The received custom packets 90 are decompressed by the compressor/decompressor 82 to produce serialised decompressed data, and de-serialised 176 by the serialiser/de-serialiser 80 using the metadata produced by the serialiser/de-serialiser 80 during serialization. As indicated at steps 178 and 180, if any source packets were compressed using ASCII compression, these packets are decompressed. The recreated original source packets are then passed in packet sequence order to the relevant kernel 20c, 20s through the relevant TUN interface 24c, 24s for transmission to the client device 14 or WAN network interface 58.

It will be understood that the packet scanner 68 is responsible for making decisions in relation to the actions to carry out on a source packet or custom packet 90.

For example, for custom packets that exit the tunnel 19, the packet scanner uses the ProtocolID field 100 in the custom header to determine routing/handling actions to be carried out on the packet:

| | |
|---|---|
| 111: Error/Reconnect | Drop packet - handled by VPN layer |
| 200: Authenticate/Handshake | Drop packet - handled by VPN layer |
| 201: Control packet | Pass packet to control packet |
| | manager 132 |
| 202: Compressed buffer | Pass packet to packet buffer manager |
| 203: Cache hit/Duplicate | Pass packet to cache/deduplication |
| | manager |
| 204: Untouched/Raw UDP packet | Bypas - send directly to TUN |
| | interface |
| 205: Untouched/Raw TCP packet | Bypas - send directly to TUN |
| | interface |

Packets that are considered to be latency sensitive prior to entry into the tunnel 19 are cached and sent directly to the TUN interface 24c, 24s. Such latency sensitive packets are typically associated with RPC traffic, including traffic associated with gaming, that would significantly affect user experience if latency were introduced through buffering and compression. Latency sensitive packets are identified when codecs 204 and 205 exist in the custom packet header.

Packets that are identified as control packets are not cached or compressed; they are routed to the control packet manager 132 for processing. Control packets are identified using protocol headers in the source packet header. For example, a TCP header includes ACK, SYN and FIN features. A high performance database is maintained in the packet scanner 68 and is used to facilitate quick identification of control packets and improved system performance.

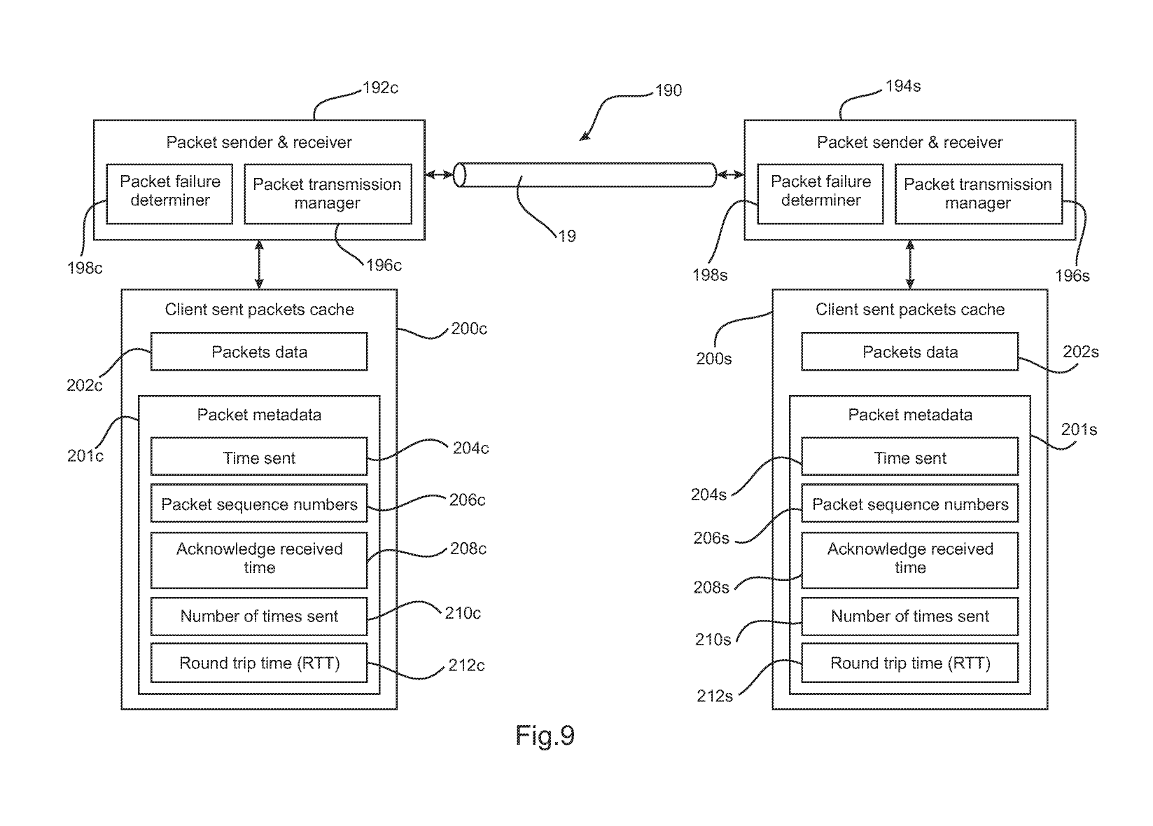

Referring to FIG. 9, a block diagram of reliability and congestion control components 190 for packet transmissions through the tunnel 19 and that use the custom header 96 is shown. The components 190 are implemented at the tunnel layer.

The components 190 include a client packet sender and receiver 192 and a server packet sender and receiver 194. Each packet sender and receiver 192, 194 includes a packet transmission manager 196c, 196s arranged to control and coordinate sending and receiving of custom packets through the tunnel 19 when the custom packets are passed to the relevant kernel 20c, 20s by the relevant TUN interface 24c, 24s; and a packet failure determiner 198c, 198s arranged to handle errors in transmission of the custom packets and in particular to make determinations as to whether retransmission of a custom packet 90 is required.

Each packet sender and receiver 192c, 192s communicates with a respective sent packets cache 200c, 200s. Each sent packets cache 200c, 200s includes a respective sent packets buffer 202c, 202s arranged to store several custom packets that have recently been sent across the tunnel 19. In this example, the 64 most recent custom packets 90 are stored in the sent packets buffer 202c, 202s. The sent packets cache 200c, 200s also stores packet metadata 201c, 201s indicative of:

the time 204c, 204s that each custom packet is sent across the tunnel 19; the sequence number 206c, 206s included in the custom 96 packet header of each custom packet 90 sent across the tunnel 19;

the acknowledge received time 208c, 208s indicative of the time that an acknowledgement is received for each custom packet 90 sent across the tunnel 19 (by virtue of the ACK number 128 included in a custom packet sent from the other side of the tunnel 19); and

the number of times 210c, 210s that the custom packet has been sent across the tunnel 19.

The packet sender and receiver 192c, 192s also calculates an average round trip time (RTT) 212c, 212s indicative of an average time to receive an acknowledgement for each of the last 32 sent custom packets 90, and stores the RTT in the sent packets cache 200c, 200s.

The packet sender and receiver 192c, 192s is arranged to use the stored packet metadata 201c, 201s to make determinations as to whether packets have most likely been lost based on a timeout threshold for the acknowledge received time 208c, 208s. If a determination is made that a custom packet has most likely been lost, the relevant custom packet is retrieved from the packet data buffer 202c, 202s and resent, and the number of sent attempts 210c, 20s is incremented in the stored packet metadata 200c, 200s.

The packet sender and receiver 192c, 192s also makes a determination as to the appropriate rate at which to send packets across the tunnel 19 based on the RTT 212c, 212s, and adjusts the packet send rate if required. In this example, based on the RTT 212c, 212s, the system adjusts the packet send rate by 5 packets per second up or down as appropriate, then monitors the impact for 3 seconds before a further adjustment is made if required. In this example, the initial send rate is 32 packets per second and maximum and minimum packet send rates of 64 and 12 packets per second are set.

The packet sender and receiver 192c, 192s also determines whether a received custom packet has already been received and if so the packet is dropped rather than processed.

The packet sender and receiver 192c, 192s also handles ordering of the custom packets 90 as the custom packets are received using the sequence number 106 contained in the custom header 96. Packets that are received out of order are held at the packet sender and receiver 192c, 192s until any preceding packets are received.

The packet sender and receiver 192c, 192s also uses the number of times sent 210c, 20s information to make a determination as to whether a major failure has occurred, and for example, if 10 attempts are made to send a packet, the tunnel 19 is deemed to be broken and a failure error is communicated to operators of the system.

According to conventional VPN regimes, the system 30 also encrypts the custom packets 90 prior to sending across the tunnel 19 and decrypts the packets as they are received at the other side of the tunnel 19. In the present example, all key exchanges required for encryption occur over a base SSL connection. If no SSL certificates are in place, the VPN service will prevent connection to the VPN and prompt the user to open the client or server application 22c, 22s.

A degree of packet scheduling also occurs at the packet buffer manager 70 which manages the timing of processing of data in the buffer 72 based on:

i) the time since data from the first source packet was added to the buffer 72 and comparison with a time threshold;

ii) the number of source packets added to the buffer 72 and comparison with a packet number threshold;

iii) the total size of data in the buffer 72 and comparison with a size threshold. If any of the thresholds are likely to be exceeded, the data in the buffer 72 is compressed and the generated custom packet 90 sent.

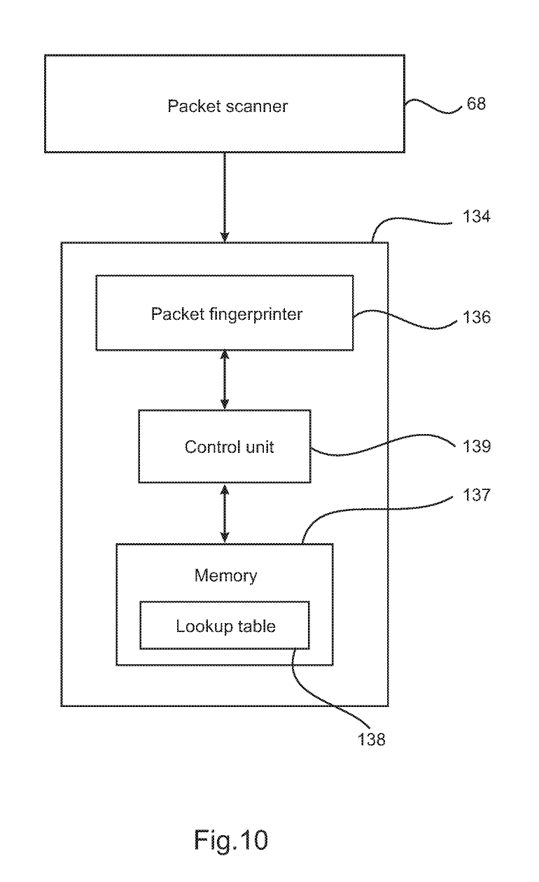

Referring to FIG. 10, an example implementation of the packet cache manager 134 is shown. The packet cache manager 134 is arranged to avoid duplication of transmission of packets across the tunnel 19.

The packet cache manager 134 in this example includes a packet fingerprinter 136 arranged to generate a unique identifier for defined packets that is repeatable in that the unique identifier will be the same each time it is generated from a packet payload, and a memory cache 137 arranged to hold a lookup table 138 that stores the payload of each packet linked to the associated unique identifier. Operations in the packet cache manager 134 are controlled and coordinated by a control unit 139.

It will be understood that since each packet manager 44, 46, 50, 52 includes a packet cache manager 134, a lookup table 138 including unique identifiers and associated packet payloads is present at both sides of the tunnel 19.

The packet cache manager 134 stores compressed custom packets and source packets that have been identified as latency sensitive. Only packets that have a payload size over a defined threshold, in this example 500 bytes, are added to the cache 137, and the capacity of the cache is defined as 200 packets. A packet queue is maintained for the cache 137 and if the queue exceeds 200 packets, the oldest packets are removed from the queue first, which in turn causes the associated identifier and packet payload to be removed from the lookup table 138.

During use, before sending a packet over the tunnel 19, the size of the packet payload is checked, and if the size is above the defined threshold size, the packet fingerprinter 136 generates the unique identifier based on the packet payload. The generated unique identifier is then used as a key in the lookup table 138 to search for a stored packet payload. If the payload is found, the packet cache manager 134 generates a cache packet that includes in the custom header 96 ‘203’ in the ProtocolID field 100 of the custom header, and a payload that includes the unique identifier but not the associated packet payload itself. The cache packet is then sent across the tunnel 19.

At the other side of the tunnel 19, the packet scanner 68 detects the cache packet by virtue of the ProtocolID indicative of a cache packet, and routes the cache packet to the cache packet manager 134. The cache packet manager 134 extracts the payload from the cache packet to obtain the unique identifier and uses the extracted unique identifier to locate the associated packet payload in the lookup table 138 at the receiving side of the tunnel 19.

If the unique identifier is found in the lookup table 138, the located packet payload is substituted back into the custom packet, which is then processed by the packet buffer manager to recreate the original source packets.

If the unique identifier is not found in the lookup table 138, the SyncCache bit in the ProtocolFlags 104a of the header of the cache packet is set to true and the cache packet sent back across the tunnel 19 to the sending side to indicate to the sending side that a problem exists and the caches 137 at both sides of the tunnel need to be reset. In response, both caches 137 are cleared.

Modifications and variations as would be apparent to a skilled addressee are deemed to be within the scope of the present invention.

The embodiments of the invention in which an exclusive property or privilege is claimed are defined as follows:

1. A network communication system for communicating data from a source network location to a destination network location, the system comprising:
a source network device comprising a source data packet buffer arranged to buffer a plurality of received source data packets that are desired to be sent from the source network location to the destination network location, the source network device arranged to combine the payload data of the plurality of received source data packets;
the source network device comprising a source compressor arranged to compress the combined payload data in the source data packets buffered in the source data packet buffer to produce compressed combined payload data, the source network device arranged to add a custom packet header to the compressed combined payload data so as to produce a custom data packet; and
the system comprising:
a destination network device comprising a destination data packet buffer arranged to buffer a custom data packet that is received at the destination network location from the source network location;
the destination network device comprising a destination decompressor arranged to decompress the combined payload data in the custom data packet in the destination data packet buffer to produce decompressed combined payload data; and
the destination network device arranged to separate the respective decompressed payload data associated with the respective source data packets and recreate the source data packets from the decompressed separated payload data.

2. The network communication system as claimed in claim 1, wherein each source data packet has a source data packet header and a source data packet payload, and the source network device is arranged to remove the source data packet header from each source data packet prior to compression of the plurality of source data packets.

3. The network communication system as claimed in claim 2, wherein the destination network device is arranged to add source data packet headers to the respective separated payload data so as to thereby recreate the source data packets.

4. The network communication system as claimed in claim 1, wherein the custom data packet is a UDP data packet.

5. The network communication system as claimed in claim 1, wherein the source network device comprises at least one source application arranged to implement at least compression of the combined payload data, the source application downloadable and installable on a source computing device so as to at least partially implement the source network device on the source computing device.

6. The network communication system as claimed in claim 1, wherein the source network device comprises a source VPN network interface and the destination network device comprises a destination VPN network interface, the source and destination VPN network interfaces creating a VPN tunnel between the source and destination network devices.

7. The network communication system as claimed in claim 1, wherein payload data of one or more of the source packets is compressed using ASCII compression and in response to compression of source packet payload data using ASCII compression, the source network device is arranged to add an ASCII compression flag to the custom packet header, the destination network device arranged to detect the ASCII compression flag in the custom packet header, and in response to decompress the associated ASCII compressed payload data.

8. The network communication system as claimed in claim 1, wherein the source network device is arranged to compress the combined payload data using a data compression algorithm.

9. The network communication system as claimed in claim 8, comprising a plurality of data compression algorithms, wherein the source network device is arranged to select a data compression algorithm based on defined criteria, and to add a combined payload compression flag to the custom packet header to indicate which compression algorithm has been used to compress the combined payload data.

10. The network communication system as claimed in claim 9, wherein the data compression algorithms include a ZLib compression algorithm and a Brotli compression algorithm.

11. The network communication system as claimed in claim 1, wherein the source network device is arranged to send a source data packet to the destination network device without combining with other source data packets and without compression in response to defined criteria.

12. The network communication system as claimed in claim 11, wherein the defined criteria may include whether the source data packet is latency sensitive.

13. The network communication system as claimed in claim 1, wherein the source network device includes a serialiser arranged to serialise the payload data of a plurality of packets that are added to the soured data packet buffer, and the destination network device include a de-serialiser arranged to de-serialise the payload data in a received custom packet.

14. The network communication system as claimed in claim 1, wherein the custom header comprises reliability metadata including data indicative of a sequence number allocated to the custom packet, data indicative of the last custom packet that was received at the source network device from the destination network device, and/or data indicative of a plurality of most recent custom packets that have been received at the source network device from the destination network device.

15. The network communication system as claimed in claim 1, wherein the source network device includes a source sent packets cache arranged to store a plurality of recent custom packets that have been sent from the source network device to the destination network device, the destination network device arranged to request retransmission of a custom packet from the source sent packets cache if the reliability metadata indicates that the custom packet has not been received at the destination network device.

16. The network communication system as claimed in claim 15, wherein the source sent packets cache includes metadata indicative of the time that a custom packet is sent from the source network device to the destination network device; an acknowledge receive time indicative of the time than an acknowledgement is received for a custom packet from the destination network device; and/or data indicative of the number of times that a custom packet has been sent from the source network device to the destination network device.

17. The network communication system as claimed in claim 1, wherein the source network device is arranged to calculate an average round rip time (RTT) for a custom packet, the RTT indicative of an average time taken between sending a custom packet and receiving an acknowledgment for the custom packet.

18. The network communication system as claimed in claim 17, wherein the source network device is arranged to make a determination as to the packet send rate at which to send custom packets from the source network device to the destination network device based on the RTT.

19. The network communication system as claimed in claim 1, wherein the source network device is arranged to manage the timing of compression of combined data in the source data packet buffer based on:
i) time since a first source packet data payload was added to the buffer comparison with a buffer fill time threshold;
ii) number of source packets added to the source data packet buffer and comparison with a buffer packet number threshold; and/or
iii) total size of data in the source data packet buffer and comparison with a buffer size threshold;
and to compress the combined payload data in the source data packet buffer if any of the thresholds are exceeded.

20. The network communication system as claimed in claim 1, wherein the source network device includes a source packet cache manager having a source duplication cache and the destination network device includes a destination packet cache manager having a destination duplication cache.

21. The network communication system as claimed in claim 20, wherein:
the source packet cache manager includes a source packet fingerprinter arranged to generate unique fingerprint data representative of a custom packet to be sent from the source network device, and to store the generated fingerprint data and the associated custom packet in the source duplication cache; and
the destination packet cache manager includes a destination packet fingerprinter arranged to generate the unique fingerprint data representative of a custom packet received at the destination network device, and to store the generated fingerprint data and the associated received custom packet in the destination duplication cache; and
wherein when a custom data packet has already been sent from the source network device to the destination network device, the source network device is arranged to send the fingerprint data associated with an already sent custom packet to the destination network device, and the destination network device is arranged to use the received fingerprint data to retrieve the custom packet from the destination duplication cache.

22. A source network device for communicating data to a destination network device, the source network device comprising:
a source data packet buffer arranged to buffer a plurality of received source data packets that are desired to be sent from the source network location to the destination network location, the source network device arranged to combine the payload data of the plurality of received source data packets; and
a source compressor arranged to compress the combined payload data in the source data packets buffered in the source data packet buffer to produce compressed combined payload data, the source network device arranged to add a custom packet header to the compressed combined payload data so as to produce a custom data packet.

23. A destination network device for receiving data communicated from a source network device, the destination network device comprising:
a destination data packet buffer arranged to buffer a custom data packet that is received at the destination network location from the source network location; and
a destination decompressor arranged to decompress the combined payload data in the custom data packet in the destination data packet buffer to produce decompressed combined payload data;
the destination source network device arranged to separate the respective decompressed payload data associated with the respective source data packets and recreate the source data packets from the decompressed separated payload data.
